(19) United States
(12) Patent Application Publication
(10) Pub. No.: US 2012/0084812 A1
(43) Pub. Date: Apr. 5, 2012

(54) System and Method for Integrating Interactive Advertising and Metadata Into Real Time Video Content

(76) Inventors: Mark Thompson, Tempe, AZ (US); Earl Cole, Santa Monica, CA (US)

(21) Appl. No.: 13/252,764

(22) Filed: Oct. 4, 2011

Related U.S. Application Data
(63) Continuation-in-part of application No. 13/252,659, filed on Oct. 4, 2011.
Application No. 13/252,659 is a continuation-in-part of application No. 13/252,555, filed on Oct. 4, 2011.
Application No. 13/252,555 is a continuation-in-part of application No. 13/247,697, filed on Sep. 28, 2011.
(60) Provisional application No. 61/404,393, filed on Oct. 4, 2010.

(51) Int. Cl. H04N 21/40

(52) U.S. Cl. 725/34

(57) ABSTRACT

A system and method for interactive video advertising comprising advertising overlays displayed on a video screen to prompt user interaction and e-commerce. Advertising overlays specifically highlight a particular region of the video content for which advertising or marketing is appropriate. Software is used to associate advertisement tags with video content, and to associate metadata with the advertisement tag. Payment account information is stored in the system and automatically transmitted to vendors. Purchase suggestions are sent to individuals, social media, and mobile media outlets.

### CROSS-REFERENCE TO RELATED APPLICATIONS

This application is a Continuation-In-Part of U.S. application Ser. No. 13/252,659, filed Oct. 4, 2011, titled “System and Method for Integrating E-Commerce Into Real Time Video Content Advertising,” which is a Continuation-In-Part of U.S. application Ser. No. 13/252,555, filed Oct. 4, 2011, titled “System and Method for Integrating Interactive Region-Based Advertising Into Real Time Video Content,” which is a Continuation-In-Part of U.S. application Ser. No. 13,247,697, filed Sep. 28, 2011, titled “System and Method for Integrating Interactive Advertising Into Real Time Video Content,” which claims priority to Provisional Patent Application No. 61/404,393 filed Oct. 4, 2010, all commonly owned.

### FIELD OF THE INVENTION

The present invention is directed toward a system and method for video advertising. More specifically, the invention relates to an in-video advertising interface that allows viewers to react to advertising impressions in real-time.

### BACKGROUND OF THE INVENTION

Targeting video advertisements to appropriate demographics remains a challenge to the advertising field. Video advertisements, whether on traditional television or through streaming Internet content, typically force viewers to watch advertisements that are not relevant for individual viewers. Such advertisements fail to efficiently reach intended audiences.

For interactive content, viewers who click on in-program advertising are typically immediately taken away from such content which is a disincentive to engage interactive advertising, therefore effectively minimizing the efficacy of advertising efforts. Advertisements on YouTube™, for example, may be clicked during video content, but immediately remove the user from the video content being viewed in order to follow what is effectively an Internet hyperlink that leads to alternate content. This is a severe disincentive for users to click on advertisements.

Other forms of video advertising, such as those by GoDaddy.com, are mere suggestions which refer a viewer to visit a website to further view additional advertising content. This necessitates that a viewer record or memorize website addresses to be inputted by the user into a computer system at a later date. This advertising mechanism suffers from numerous disadvantages. Specifically, it relies on a viewer's memory and forces the viewer to undergo a large number of discrete steps such as accessing a computer, opening a web browser, entering link information; and navigating the internet to view advertising content. Additionally, viewers may remain anonymous which is a disadvantage to advertisers who attempt to collect viewer data.

Other advertisers have created interactive video advertising systems that allow advertisements to be accessed from a user interface, yet suffer from the limitation that a user must have a specific digital video recordation device to view such content. Furthermore, these advertisements only originate in advertising content, and there is a need in the advertising marketplace to place interactive advertisements in featured video content.

Accordingly, there is a need for advertisers to both personalize advertising to qualified target demographics while increasing clickthrough rates for interactive video advertising so as to maximize an advertiser's return on investment. Specifically, there is a need for a system that minimizes content interruption while gathering relevant personalized consumer data so that relevant advertisements reach relevant audiences through video, internet, mobile, social media, and traditional advertising vehicles.

### SUMMARY OF THE INVENTION

This invention overcomes many of the current limitation in interactive advertising. In one embodiment, the system comprises a video display which displays an advertisement tag that prompts a user interaction and creates a registry of an interaction history.

The video display is a device selected from the group consisting of a television, monitor, cable television system, satellite television system, digital video recorder, video game system, portable video game system, digital media receiver, telephone, smartphone, personal digital assistant, computer system, laptop computer, and a tablet computing device.

User interaction comprises at least one of a remote control, computer mouse, trackball, touchpad, pointing stick, keyboard, joystick, game controller, webcam, digital camera, touchscreen, stylus, laser rangefinder, motion sensor, proximity sensor, barcode reader, microphone, and RFID tag.

The advertisement tag is at least one of a visual notification, audible notification, and a tactile notification, and in one embodiment, substantively relates to at least one of a product, service, song, person, scene, and location. The advertisement tag indicates at least one of a product, class of products, service, class of services, sweepstakes, and contest.

Computer software associates the advertisement tag with video content on the video display. The computer software also associates metadata with the advertisement tag. The metadata comprises data indicating at least one of advertisement type, advertisement category, product brand, service brand, the description of the product tagged, and keywords. The metadata is saved in electronic storage means which is at least one of a file, database, network-accessible file, and network-accessible database.

An interaction history archive in the form of an advertising cart user interface is populated by the interaction history.

The system executes advertisement positioning algorithms that review and prioritize the interaction history created by the user. The data sources used in these algorithms are selected from the group consisting of marketing parameters, advertising data, interaction history archive data, probabilistic market segmentation analysis data, and combinations thereof.

Probabilistic market segmentation analysis algorithms are executed in order to choose and display advertising content based upon the interaction history. The system utilizes data for probabilistic market segmentation analysis algorithms including marketing parameters, advertising data, market data, interaction history archive data, user behavior data, user profile data, external user profile data, external interaction history archive data, external user behavior data, and combinations thereof.

Advertising content is disseminated from the user interface. This advertising content may be distributed to social media networks.

The method for interactive video advertising is a series of steps, including the displaying of video content on a video display, the associating of an advertisement tag with the video content, the displaying of an advertisement tag on the video display in conjunction the video content, the interacting with the video display thereby populating an interaction history archive with a record of such interaction, the associating of the record of interaction with advertising content, the displaying of the prioritized advertising content in a user interface, the accessing of the user interface, and the distributing of advertising data to other individuals or networks.

The video content display utilized in the method for interactive video advertising comprises a device selected from the group consisting of a television, monitor, cable television system, satellite television system, digital video recorder, video game system, portable video game' system, digital media receiver, telephone, smartphone, personal digital assistant, computer system, laptop computer, and tablet computing device.

The computer software utilized in the method for interactive video advertising associates the advertisement tag with video content and also synchronizes the advertisement tag to the video content. The software also associates metadata with the advertisement tag.

The advertisement tag comprises at least one of a visual notification, audible notification, and tactile notification.

The method of interacting with the advertising tag on the video display is through a remote control, computer mouse, trackball, touchpad, pointing stick, keyboard, joystick, game controller, webcam, digital camera, touchscreen, stylus, laser rangefinder, motion sensor, proximity sensor, barcode, or combinations thereof. Upon interaction, the interaction is saved in an interaction history archive which is stored in a file, database, computer memory, computer data storage, computer network files, computer network memory, computer network data storage, or combinations thereof.

### BRIEF DESCRIPTION OF THE DRAWINGS

For a fuller understanding of the invention, reference is made to the following detailed description, taken in conjunction with the accompanying drawings illustrating various embodiments of the invention:

FIG. 1 is a flow chart showing the major components of the advertising system;

FIG. 2 is a flow chart showing one embodiment of the viewer profile creation scheme;

FIG. 3 is a flow chart showing one embodiment of the interactive advertisement system;

FIG. 4 is a flow chart showing the major components of the region-based advertisement selection system;

FIG. 5 is a flow chart showing one embodiment of the region-based advertisement selection system;

FIG. 6 is a flow chart showing one embodiment of e-commerce integration into the interactive advertisement system.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview of the System

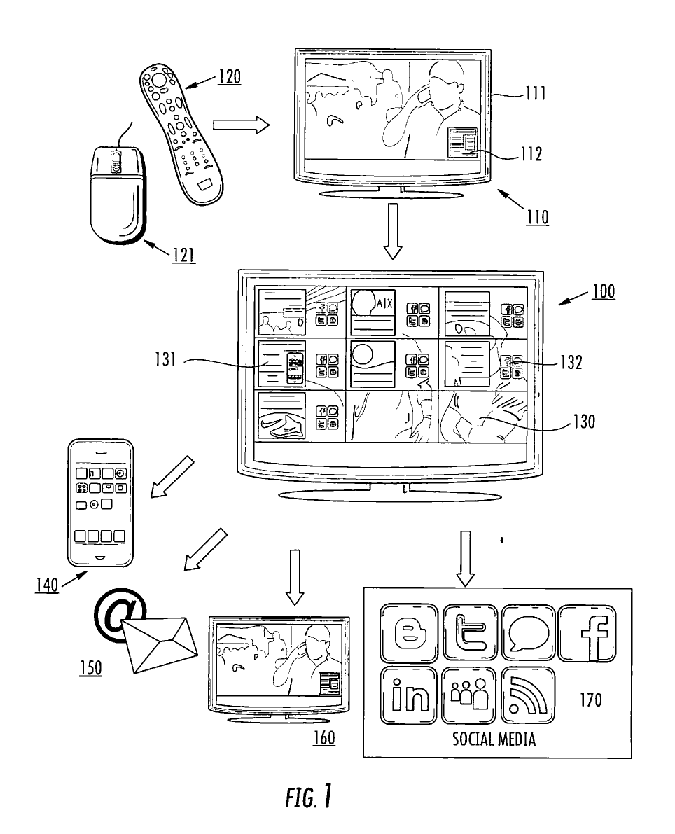

FIG. 1 illustrates the central physical component of the system 100, which may be a video display device 110. The video display device 110, is capable of displaying video content 111 and may be viewed by the user of the system 100. The video display device 110 is typically a television, video projection system, computer system, tablet device, smartphone, or any device capable of displaying video content 111.

The system 100 may be hardware based, such as integrated into a television, cable box, satellite TV receiver, digital video recorder (e.g. Tivo™), video game system (e.g. Playstation™, Nintendo wii™), portable video game system (e.g. Nintendo DS™) digital media receiver (e.g. Apple TV™), smartphone (e.g. Android™, Blackberry™, iPhone™), computer based system (e.g. desktop pc, laptop pc, tablet computing device, PDA), or any hardware capable of displaying video content 111. Alternatively, the system 100 may be software based such that no hardware integration is required for operation of system 100. Such systems 100 could be embedded in internet sites, Internet services, cable services, streaming video content services, or any other mechanism for displaying video content 111 (e.g. Netflix™, Hulu™, GoogleTV™, Vevo™, digital television network websites, cable services) and could be based on custom software solutions or via means of displaying internet content well established in the art (e.g. Adobe™ Flash™, HTML, XML, CSS, JavaScript, VBScript). Video content 111 includes audio content with or without accompanying video such as exemplified by streaming audio services (e.g. Spotify™, Grooveshark™, Pandora™, Google Music™, Rdio™, or digital cable or satellite TV music channels).

Advertisement overlays or “tags” 112 may be displayed over video content 111 on the display device 110. A tag 112 may be any visual or audible or tactile notification to the user, typically a highlighted region, boxed region, flashing region, vibration, AdBug™, or any other indication that notifies the user that the video content 111 is tagged. Tags 112 may appear over video content 111 in real-time for a duration that may be designated by viewer preferences or alternatively by system 100 parameters not accessible by the viewer. Tags 112 are designed to highlight physical products, service, songs, persons, scenes, locations, or any video content 111 to which an advertiser wishes to direct a viewer's attention. Inclusion of a tag 112 does not preclude traditional forms of advertisement, such as commercial breaks and pre-roll ads. Commercial breaks may, however, also employ the use of tags 112. A software development kit (SDK) may be used by advertisers and programmers as a tool to tag 112 video content 111. The SDK ensures proper tag placement and timing. Tags are accompanied by metadata not limited to product/service type, genre, brand, scene, location, key words, demographic information, and user profile target parameters.

Users may interact with the system 100, by reacting to tags 112 on the video display device 110. The user may react using an input device 120, 121. Typical user interaction may be via using remote control 120, computer mouse 121, infrared input device, radio frequency input device, Bluetooth™ input device, RFID device, touch-sensitive screen input, interacting with a motion sensing input device (e.g. Kinect™, iPhone™), or any other form of device input.

Upon user interaction to tags 112, the interaction is recorded by the system 100. The record of interaction may be saved locally on the hardware used to access the system 100, or may be saved remotely in a location accessible by the system 100. The user may access a user interface 130 in order to access the record of user interactions recorded by the system 100. The user interface 130 may be text-based or a graphical user interface. The user interface 130 provides a means to indicate with which tags 112 a viewer has interacted by displaying a tag indication 131, which may allows a user to access additional advertising materials.

Tag indications 131 may be in icon form, photographic representations, audible cues, textual regions, menus, or any other means to indicate a tag 112 has been selected by the user.

Tag indications 131 may be sorted, deleted, saved, or sent to other-viewer user interfaces 130. The video content 111 does not need to be stopped or paused upon tag-prompted user interaction with the system 100, and the user may continue to view uninterrupted video content 111 without first accessing a user interface 130. Tag indications 131 may be viewed in the user interface 130 at a later time.

From within the user interface 130, advertising content may be relayed to mobile media devices 140, email and traditional mail 150, video display devices 160, social media networks 170, and other digital, electronic, and communications means known or unknown in the art. This advertising content may be relayed upon user interaction with controls 132 in the user interface 130 or without any active user interactions.

### User Profile Creation and Analysis

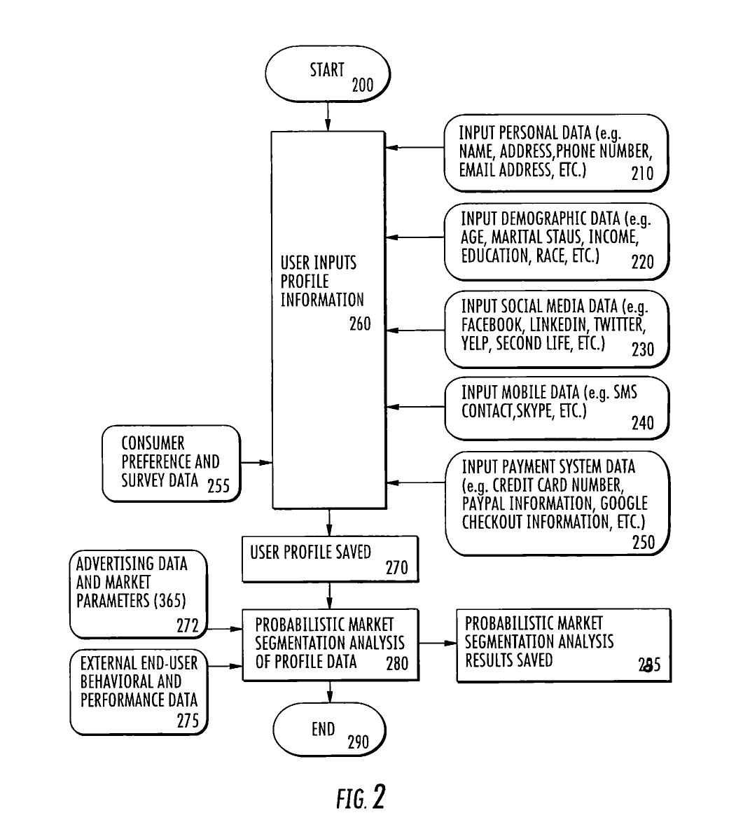

FIG. 2 shows how user profile information 260 may enter the system 100 and the general flow of data for market analyses 270, 272, 275, 280, 285. A user profile may be a compilation of information that may include personal data 210, demographic data 220, social media data, 230, mobile network data 240, payment data 250, consumer preference and survey data 255, or any other data known in the art to be relevant to user profiles and advertising. A user profile 260 is not necessary for the system 100 to function, but will augment calculations 280, 360 designed to target appropriate advertising content 365 to appropriate viewers.

Personal data 210 may be saved, which may include name, address, phone numbers, email addresses, or any other data used to describe or identify an individual user. Demographic data 220 may be saved, which may include age, marital status, income, educational information, race, ethnicity, religion, or any other personal information. Social media data 230 may be saved, which may include account login information, handles or usernames, social network preferences, or any other information related to social media use and accounts. Mobile and communication data 240 may be saved, which may include SMS contact information, geo-location data, voice over internet protocol (VoIP) information, or any other information related to mobile communications, communication technology, and related devices. Payment system data 250 may be saved, which may include credit card information or online payment system information or direct access to financial institutions such as Paypal™ or Google™ checkout, credit card accounts, bank accounts, credit card processors, electronic banking, or any other financial information or access. General survey data 255 may be saved, which may include shopping preferences, advertising preferences, buying habits, online purchasing behavior, brand awareness questions, customer satisfaction surveys, or any other consumer-related preference, behavior, habit, or survey data.

User behavioral data may also be associated with a user profile 260. This data may include information related to recorded interactions with placed products, information about interactions from the user interface 130, how long users remain engaged with advertisements, how users share advertisements and information within their social network 170, what type of advertisements are being saved (or not being saved) for later viewing in the user interface 130, web browser or internet cookie information, geo-tag information from mobile devices, user contact lists, and other user behavior data known in the art to be useful for advertising purposes. User data may be collected to calculate advertising cost per click, cost per mille, cost per engagement, cost per impression, cost per acquisition, and other advertiser cost metrics.

User profile information 260 may be saved. The user profile information 260 may be saved on the system 100 in a file or database, or may be saved at an external location in a file or database electronically accessible by the system 100.

User profile information 260 may be utilized for probabilistic market segmentation analysis (PMSA) 280 and other marketing analytics. PMSA 280 encompasses the use of data and algorithms associated with advertising efforts. PMSA 280 may include the determining of appropriate target audiences, population segments, or individual users of the system 100 for particular advertising content. PMSA 280 may include the determining of advertisement timing, duration, version, content, tagging means, social media outlet choice, digital and electronic communication means choice, or any other advertising choice or strategy employed to maximize advertising efficacy known in the art.

Data provided by advertisers 272, user profile information from external users 275, external-user performance data 275, and other information known in the art to be useful for marketing analyses may also be utilized for PMSA 280.

Data provided by advertisers 272 may include market segment data, price discrimination data, customer retention data, regional market data, product differentiation data, and any other data known in the art utilized to improve marketing and advertising efficacy. These data may be used to determine the type, frequency, and duration advertisements to be featured in a user interface 130, the type, frequency, and duration of tags 112, regionally specific advertisement choice, alternate and generic advertisement choice, communication modality choice, and any other choices known in the art made related to maximizing advertising or marketing efficacy.

User profile information from external users 275 may include all the same type of data collected for a local user to be saved in a local user profile 270 and described in detail above. External users include the body of users who access any aspect of the system 100, and includes users with a user profile 260, and those without.

External user performance data 275 may include information related to recorded user interactions with placed products, information from the user interface 130, how long users remain engaged with advertisements, how users share advertisements and information within their social network 170, and what type of advertisements are being saved (or not being saved) for later viewing, web browser or internet cookie information, geo-tag information from mobile devices, user contact lists, and other external user data or analyses known in the art to be useful for advertising purposes.

### Operation of the System

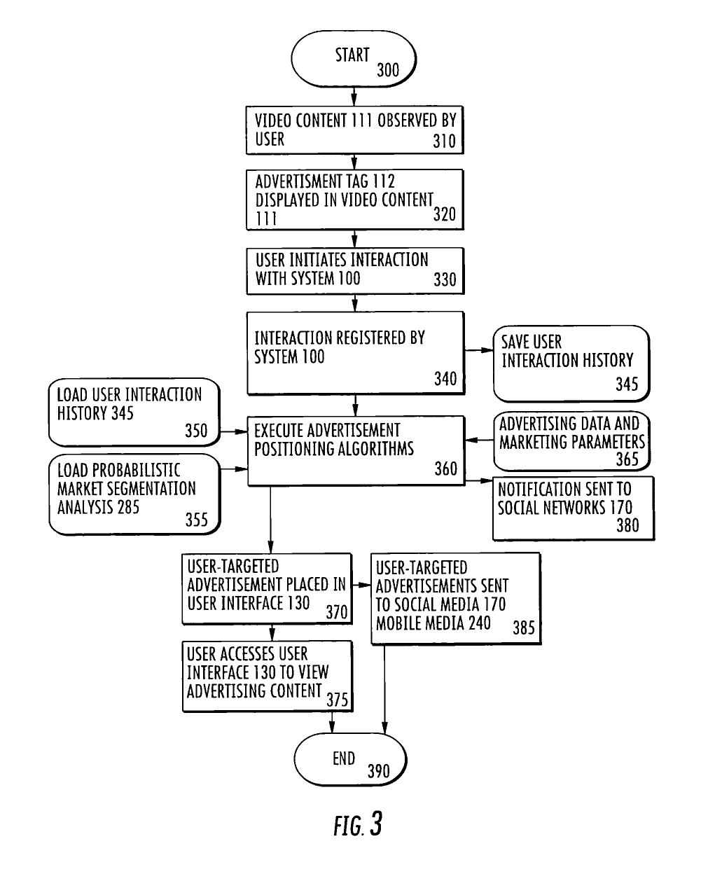

FIG. 3 is a detailed flow chart of one embodiment describing the operation of the system 100. In this preferred embodiment, the process begins when a user observes 310 video content 111 on a display device 110.

In conjunction with video content 111 interactive advertisements may be displayed 320 preferably in the form of tags 112. The act of displaying 320 a tag 112 may be via visual means, audible means, tactile means, or via any other means indicating to a user that a tag 112 is present.

At a time point during or after a tag 112 is displayed 320 on a display device 110, a user may initiate an interaction 330 with the system 100. This user interaction 330 may be registered 340 by the system 100, and a history of user interaction may be saved 345 for marketing, advertising, or any related system 100 purposes.

Saved user interaction history data 345 may be utilized separately or in conjunction with PMSA data 280 which may be utilized separately or in conjunction with advertising content data 365 and marketing parameters 365 for use in advertisement positioning algorithms 360, or for any related system 100 purposes. Advertisement position algorithms 360 may be utilized to calculate which particular tag indications 131 and associated advertising or marketing materials are accessible to a user in a user interface 130. Additionally, advertisement position algorithms 360 may target particular advertising content 365 to particular users, user groups, demographic groups, social media networks 170, or mailing and distribution lists or any other advertising or marketing outlets known in the art. Notifications may be sent 380 to social networks 170 either automatically or as a result of user interaction with controls 132 in the user interface 130. Notifications sent 380 to social networks 170 may be automated, customized, or manually entered messages or advertising materials, or may be popularity indicators such as “Like” notifications found on facebook™ or “+1” notifications found on Google™. A user may also, from the user interface 130 controls 132, relay actual advertising content 385 to social media networks 170 and mobile media 140 outlets.

After advertising content 365 is made accessible to a user in a user interface 130, a user may navigate said user interface 130 to view advertising content 375 by interacting with tag indications 131. Navigation may be via any input device known in the art.

### Method of Integrating Interactive Advertising Content

FIG. 3 provides, by way of example, a method of integrating interactive video content into real-time video content. The method begins when video content 111 is observed 310 by a user. An advertisement tag 112 is then displayed 320 over the video content 111.

A user then initiates an interaction 330 with the system 100 as a reaction to the advertisement tag 112. This interaction 330 is then registered 340 and saved 345 by the system 100.

Advertising content is then prioritized through advertisement positioning algorithms 360. User interaction history 345 may be loaded 350 in the system 100 for use by advertisement positioning algorithms. Additionally, probabilistic market segmentation analysis 285 may be loaded 355 in the system 100 for use by advertisement positioning algorithms. Advertising data and marketing parameters may also be loaded 365 in the system 100 for use by advertisement positioning algorithms.

Notifications may then automatically be sent 380 to social networks 170. User-targeted advertisements may also be placed 370 in the user interface 130. A user may then access the user interface 130 to view 375 a tag indication 131 which allows a viewer to access additional advertising material. Advertising content may be sent 385 by the user from the user interface 130 by interacting with controls 132 found therein.

### Region-Based Advertisement Selection

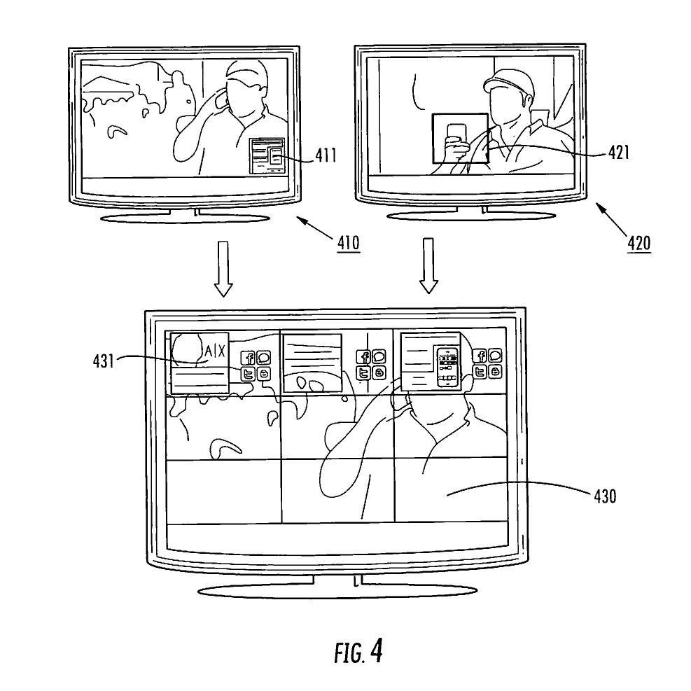

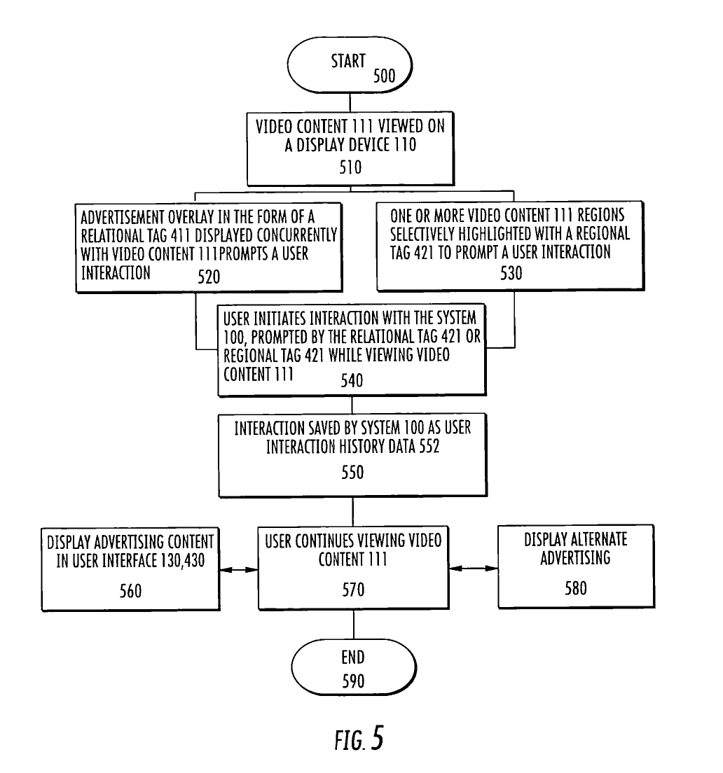

FIGS. 4 and 5 describe the preferred embodiment of region-based advertising on the system 100. FIG. 4 shows variations of advertisement tags 112 displayed over video content 111 on a display device 110, specifically, relational tags 411 and regional tags 421. In one embodiment, a relational tag 411 is displayed 410, the content of which directly relates to the substance of the video content 111 shown on a display device 110. For example, if the video content 111 included a depiction of an actor using a particular model of cellular telephone, the relational tag 411 in this particular case could be an advertisement for that particular model of cellular telephone. The use of such a relational tag 411 is not limited to physical products, but could be for advertising efforts related to music, services, actors, scene locations, scene dialogue, or any other video content 111 shown on a display device 110 for which advertising or marketing would be appropriate.

In another embodiment, a regional tag 421 is displayed 420, highlighting a particular region of the video content 111. In this embodiment 420, the regional tag 421 is any visual or audible or tactile notification to the user, typically a highlighted region, boxed region, circumscribed region, flashing region, or any other indication or combination of indications that notifies the user that a particular portion of the video content 111 is tagged.

Regional tags 421 highlight physical products, service, songs, persons, scenes, locations, or any video content 111 to which an advertiser or marketer wishes to direct a viewer's attention. For example, if the video content 111 included a depiction of an actor using a particular model of cellular telephone, the regional tag 421 in this particular case could be a highlighted box around the cellular telephone. As the actor's hand, and therefore phone, moves on the screen, the regional tag 421 tracks that same motion path, therefore continually highlighting the cellular telephone.

A user interacts with relational tags 411 or regional tags 421 in the same ways by which interactions with tags 112 in general occur. Upon user interaction to relational tags 411 or regional tags 421, the interaction is recorded by the system 100. The record of interaction may be saved locally on the hardware used to access the system 100, or saved remotely in a location accessible by the system 100. The user accesses a user interface 130, 430 in order to access the record of user interactions recorded by the system 100.

The user interface 130, 430 is text-based or a graphical user interface. The user interface 130, 430 provides a means to indicate that a user interaction with the system 100, in response to a relational tag 411 or regional tag 421, has occurred. The user interface 130, 430 displays a tag indication 131, 431 which allows a user to access additional advertising materials. Tag indications 131, 431 are in icon form, photographic representations, audible cues, textual regions, menus, or any other means to indicate a tag 112 has been selected by the user. Tag indications 131, 431 are sorted, deleted, saved, or sent to other-viewer user interfaces 130, 430. The video content 111 does not need to be stopped or paused upon tag-prompted user interaction with the system 100, and the user may continue to view uninterrupted video content 111 without first accessing a user interface 130, 430.

Tag indications 131, 431 are viewed in the user interface 130, 430 at a time point after initial display of either a relational tag 411 or regional tag 421. The video content 111 does not need to be stopped or paused upon a tag-prompted user interaction with the system 100, and the user may continue to view uninterrupted video content 111 without first accessing a user interface 130, 430.

### Region-Based Advertisement Selection

FIG. 5 illustrates, by way of example, one embodiment of region-based advertising on the system 100. In this preferred embodiment, the process begins when a user views (at 510) video content 111 on a display device 110.

In conjunction with video content 111, interactive advertisements are displayed (at 520, 530 preferably) in the form of relational tags 411 or regional tags 421.

At a time point during or after a relational tag 411 or regional tag 421 is displayed (at 520, 530) on a display device 110, a user initiates an interaction 540 with the system 100.

This user interaction (at 540) is registered and saved 550 for marketing, advertising, or any related system 100 purposes. This interaction is saved 550 as user interaction history data 552.

Saved user interaction history data 552 is utilized separately or in conjunction with PMSA data 280 which is utilized separately or in conjunction with advertising content data 365 and marketing parameters 365 for use in advertisement positioning algorithms 360, or for any related system 100 purposes. Advertisement position algorithms 360 are utilized to calculate which particular tag indications 131, 431 and associated advertising or marketing materials are accessible to a user in a user interface 130, 430. This occurs in the system 100 without a user interrupting viewing content 111. A user may therefore continue to watch video content (at 570) without entering the user interface 130, 430.

Advertisement position algorithms 360 target particular advertising content 365 to particular users, user groups, demographic groups, social media networks 170, or mailing and distribution lists or any other advertising or marketing outlets known in the art. Such advertising content is viewed 560 in the user interface 130, 430.

Although advertisement position algorithms 360 target particular advertising content 365 to particular users, user groups, demographic groups, social media networks 170, or mailing and distribution lists or any other advertising or marketing outlets known in the art, alternative advertisements may nonetheless populate the user interface 130, 430.

Alternative advertisements may include advertisements for generic products, substitute goods known to be popular in a user's particular market, local business advertising, competitor's advertising, advertising for complimentary goods or services, or combinations thereof. For example, if a drug company's pharmaceutical is featured in video content, advertising content for a generic version of the pharmaceutical could alternatively populate the user interface 130, 430.

### Method of Providing Interactive Region-Based Video Advertising

FIG. 4 provides, by way of example, a method of integrating interactive region-based video advertising into real-time video content. The method begins when video content 111 is observed 310 by a user. An advertisement tag 112, 411, 421 is then displayed at 420 over the video content 111.

In one embodiment 410, a relational tag 411 is displayed, the content of which directly substantively relates to the video content 111 shown on a display device 110. The relational tag 411 is used for products, promotions related to music, services, actors, scene locations, scene dialogue, or any other video content 111 shown on a display device 110 for which advertising or marketing would be appropriate.

In another embodiment, a regional tag 421 is displayed 420, highlighting a particular region of the video content 111. The regional tag 421 is any visual or audible or tactile notification to the user, typically a highlighted region, boxed region, flashing region, or any other indication or combination of indications that notifies the user that a particular portion of the video content 111 is tagged. Regional tags 421 highlight physical products, services, songs, persons, scenes, locations, or any video content 111 to which an advertiser or marketer wishes to direct a viewer's attention.

A user next initiates an interaction 330 with the system 100 as a reaction to the relational tag 411 or regional tag 421. This interaction 330 is then registered 340 and saved 345 by the system 100.

Advertising content is then prioritized through advertisement positioning algorithms 360. User interaction history 345 is loaded 350 in the system 100 for use by advertisement positioning algorithms. Additionally, probabilistic market segmentation analysis 285 is loaded 355 in the system 100 for use by advertisement positioning algorithms. Advertising data and marketing parameters are also loaded 365 in the system 100 for use by advertisement positioning algorithms.

Notifications are then automatically sent 380 to social networks 170. User-targeted advertisements are also be placed 370 in the user interface 130, 430. A user then accesses the user interface 130, 430 to view 375 a tag indication 131, 431 which allows a viewer to access additional advertising material. Advertising content is sent 385 by the user from the user interface 130, 430 by interacting with controls 132 found therein.

### e-Commerce Integration into the Interactive Advertisement System

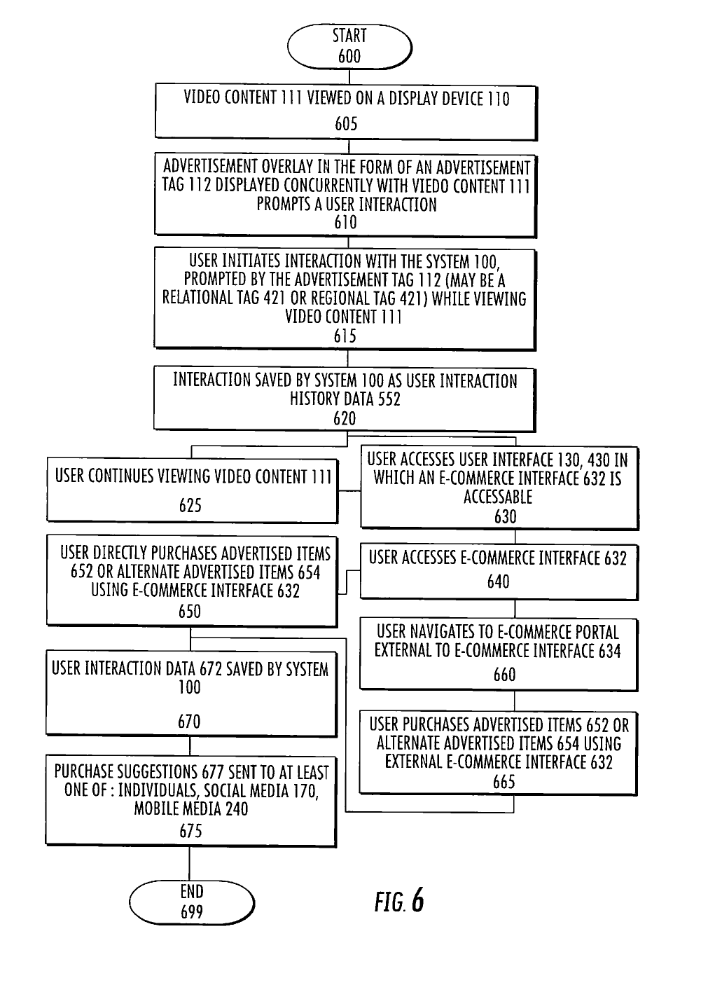

FIG. 6 illustrates, by way of example, one embodiment of advertising-linked e-commerce on the system 100. In this preferred embodiment, the process begins when a user views 605 video content 111 on a display device 110.

In conjunction with video content 111, advertising overlays are displayed 610 preferably in the form of relational tags 411 or regional tags 421, thereby prompting a user interaction 610.

A user interacts 615 and this interaction is registered and saved 620 for marketing, advertising, or any related system 100 purposes. This interaction is saved 620 as user interaction history data 552.

Users interact 615 with the system 100, by reacting to tags 112, 411, 421 on the video display device 110. The user reacts using an input device 120, 121. Typical user interaction comprises using a remote control 120, computer mouse 121, infrared input device, radio frequency input device, Bluetooth™ input device, RFID device, touch-sensitive screen input, interacting with a motion sensing input device (e.g. Kinect™, iPhone™), or any other form of device input.

Saved user interaction history data 552 is utilized separately or in conjunction with PMSA data 280 which is utilized separately or in conjunction with advertising content data 365 and marketing parameters 365 for use in advertisement positioning algorithms 360, or for any related system 100 purposes. Advertisement position algorithms 360 are utilized to calculate which particular tag indications 131, 431 and associated advertising or marketing materials are accessible to a user in a user interface 130, 430. This occurs in the system 100 without a user interrupting viewing content 111. A user may therefore continue to watch video content 625 without entering the user interface 130, 430.

From within the user interface, 130, 430, users access 640 an e-commerce interface 632. An e-commerce interface 632 comprises a text-based or graphical user interface wherein users may directly purchase items, services, and madia that are advertised. Stored payment systems data 250 from a user profile 260 are used to directly transfer payment for a purchase. Alternatively, payment account information are input into the e-commerce interface and either be used only one time or alternatively saved for future purchases. Payment system data 250 includes credit card information or online payment system information or direct access to financial institutions such as Paypal™ or Google™ checkout, credit card accounts, bank accounts, credit card processors, electronic banking, or any other financial information necessary to make a purchase.

Using the e-commerce interface 632, advertised items 652 are directly purchased 650. Advertised items 652 are items for sale such as physical products, services, or media that directly and substantively relate to video content 111. For example, if the video content 111 included a depiction of an actor using a particular model of cellular telephone, a regional tag 421 could highlight the cellular telephone, and the advertising that is available in the e-commerce interface 632 could be for that particular model of cellular telephone (i.e. advertised item 652).

Using the e-commerce interface 632, alternate advertised items 654 are also directly purchased 650. Alternate advertised items 654 are items for sale such as physical products, services, or media that tangentially relate to video content 111. Examples of alternate advertised items 654 may include competitor products, services, or media; local products, services, or media (as an offering based on a national brand's advertisement, for example); or products or services that compliment a another product or service. For example, if the video content 111 included a depiction of an actor using a particular model of cellular telephone, a regional tag 421 could highlight the cellular telephone, yet the advertising that is available in the e-commerce interface 632 could refer to other models of similar telephones, a cellular telephone network service, or a national retailer that sells cellular telephones.

An alternative embodiment of an alternate advertised item 654 comprises advertisement tags 112, 411, 421 relating to individuals, such as actors, in the video content 111. For example, were an actor's character tagged 112, 411, 421, the user interface 130, 430 displays tag indications 131, 431 that advertise the character's shoes, clothing, a charity wherein the actor or character is involved, or any other advertising content known in the art. The e-commerce interface 632 allows purchases or donations related to alternate advertised items 654.

Instead of making purchases directly 650 from the e-commerce interface 632, a user, in an alternative embodiment, navigates 660 to external e-commerce interfaces 634. External e-commerce interfaces include retailer interfaces, such as websites, that allow a user to make purchases. Using an external e-commerce interface 634, advertised items 652 or alternate advertised items 654 are purchased 665.

The user interaction data 672 is saved 670 on the system 100 in a file or database, or saved at an external location in a file or database electronically accessible by the system 100.

User interaction data 672 is utilized for probabilistic market segmentation analysis (PMSA) 280 and other marketing analytics. PMSA 280 encompasses the use of data and algorithms associated with advertising efforts. PMSA 280 includes the determining of appropriate target audiences, population segments, or individual users of the system 100 for particular advertising content. PMSA 280 includes the determining of advertisement timing, duration, version, content, tagging means, social media outlet choice, digital and electronic communication means choice, or any other advertising choice or strategy employed to maximize advertising efficacy known in the art.

Saved user interaction data 672 is utilized separately or in conjunction with PMSA data 280 which is utilized separately or in conjunction with advertising content data 365 and marketing parameters 365 for use in advertisement positioning algorithms 360, or for any related system 100 purposes. These data 672, 280, 365 are used to suggest product purchases for advertised items 652 or alternate advertised items 654. Advertisement position algorithms 360 are utilized to calculate which particular tag indications 131, 431 and associated advertising or marketing materials are accessible to a user in a user interface 130, 430.

Additionally, advertisement position algorithms 360 target particular advertising content 365 to particular users, user groups, demographic groups, social media networks 170, or mailing and distribution lists or any other advertising or marketing outlets known in the art. Advertisement position algorithms 360 may also calculate which purchasing suggestions 677 to send 675 users, other individuals, social media 170, and mobile media networks 240. Purchasing suggestions 677 are sent 675 to social networks 170 automatically or as a result of user interaction with controls 132 in the user interface 130. Purchasing suggestions 677 sent 675 to social networks 170 may be automated, customized, or manually entered messages or advertising materials, or may be popularity indicators such as “Like” notifications found on facebook™ or “+1” notifications found on Google™.

### Advertisement Tag Content and Metadata Association

One embodiment, by way of example, comprises the use of computer software to create an advertisement tag 112, 411, 421 for audio and video content 111. A software operator selects static regions, dynamic regions, and/or motion paths within the video content 111 to be associated with an advertisement tag.

The computer software also allows a software operator to associate metadata with the advertisement tag 112, 411, 421. The metadata comprises data indicating at least one of advertisement type, advertisement category, product brand, service brand, description of the product tagged, advertising content data 365, marketing parameters 365, keywords, and any other metadata known in the art. The metadata is used for classification of advertisements, advertisement positioning algorithms 360, and PMSA data 280, and for any use known in the art.

The advertisement tag 112, 411, 421 and metadata are saved in electronic storage means comprising at least one of a file, database, network-accessible file, and network-accessible database. Since this data is saved, product data and metadata may be tracked and measured to calculate advertising cost per click, cost per mille, cost per engagement, cost per impression, cost per acquisition, and other advertiser cost metrics.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which we claim:

1. A system for interactive video advertising, the system comprising:
a video display capable of displaying an advertisement tag, wherein the advertisement tag prompts a user interaction and allows a registry of an interaction history;
computer software for associating an advertisement tag with video content on the video display;
an interaction history archive, in the form of an advertising cart user interface, that allows the population and temporal storage of the interaction history; and
distribution means for disseminating advertising content.

2. The system for interactive video advertising of claim 1, wherein the video display comprises a device selected from the group consisting of a television, monitor, cable television system, satellite television system, digital video recorder, video game system, portable video game system, digital media receiver, telephone, smartphone, personal digital assistant, computer system, laptop computer, and a tablet computing device.

3. The system for interactive video advertising of claim 1, wherein the advertisement tag comprises at least one of a visual notification, audible notification, and a tactile notification.

4. The system for interactive video advertising of claim 1, wherein the advertisement tag substantively relates to at least one of a product, service, song, person, scene, and location.

5. The system for interactive video advertising of claim 1, wherein the advertisement tag indicates at least one of a product, class of products, service, class of services, sweepstakes, and contest.

6. The system for interactive video advertising of claim 1, wherein the user interaction comprises at least one of a remote control, computer mouse, trackball, touchpad, pointing stick, keyboard, joystick, game controller, webcam, digital camera, touchscreen, stylus, laser rangefinder, motion sensor, proximity sensor, barcode reader, microphone, and RFID tag.

7. The system for interactive video advertising of claim 1, wherein advertising content is disseminated from the user interface.

8. The system for interactive video advertising of claim 1, comprising an advertisement positioning algorithm that reviews and prioritizes the interaction history created by a user acknowledgment of the advertisement tag.

9. The system for interactive video advertising of claim 1, wherein the computer software associates metadata with an advertisement tag.

10. The system for interactive video advertising of claim 8, comprising means for allowing probabilistic market segmentation analysis in order to display advertising content in the user interface based upon the interaction history.

11. The system for interactive video advertising of claim 9, wherein the metadata is saved in electronic storage means.

12. The system for interactive video advertising of claim 9, wherein the metadata comprises data indicating at least one of advertisement type, advertisement category, product brand, service brand, the description of the product tagged, and keywords.

13. The system for interactive video advertising of claim 11, wherein the electronic storage means comprises at least one of a file, database, network-accessible file, and network-accessible database.

14. A method for interactive video advertising, the method comprising the steps of:
displaying video content on a video display;
associating an advertisement tag with the video content;
displaying an advertisement tag on the video display in conjunction the video content;
interacting with the video display thereby populating an interaction history archive with a record of such interaction;
associating the record of interaction with advertising content;
storing the prioritized advertising content in a user interface;
accessing the user interface;
distributing the advertising data to other individuals or networks.

15. The method for interactive video advertising according to claim 14, wherein associating the advertisement tag with the video content comprises software for synchronizing the advertisement tag to the video content.

16. The method for interactive video advertising according to claim 15, wherein the software associates metadata with the advertisement tag.

17. The method for interactive video advertising according to claim 14, wherein the video content displaying comprises a device selected from the group consisting of a television, monitor, cable television system, satellite television system, digital video recorder, video game system, portable video game system, digital media receiver, telephone, smartphone, personal digital assistant, computer system, laptop computer, and tablet computing device.

18. The method for interactive video advertising according to claim 14, wherein the advertisement tag comprises at least one of a visual notification, audible notification, and tactile notification.

19. The method for interactive video advertising according to claim 14, wherein the interacting with the video display comprises at least one of a remote control, computer mouse, trackball, touchpad, pointing stick, keyboard, joystick, game controller, webcam, digital camera, touchscreen, stylus, laser rangefinder, motion sensor, proximity sensor, and barcode.

20. The method for interactive video advertising according to claim 15, wherein advertising content is distributed to social media networks.
